(19) United States
(12) Patent Application Publication
(10) Pub. No.: US 2020/0108328 A1
(43) Pub. Date: Apr. 9, 2020

(54) Sprinkler System and Method Utilizing Atmospheric Water Generation

(71) Applicant: Cory Jacob Hammock, Salt Lake City, UT (US)

(72) Inventor: Cory Jacob Hammock, Salt Lake City, UT (US)

(21) Appl. No.: 16/239,003

(22) Filed: Jan. 3, 2019

Related U.S. Application Data
(63) Continuation-in-part of application No. 16/152,786, filed on Oct. 5, 2018.

(51) Int. Cl. B01D 5/00; B01D 53/18; E03B 3/03; E03B 3/28

(52) U.S. Cl. CPC B01D 5/009; B01D 53/185; B01D 5/0015; B01D 53/263; B01D 5/0081; E03B 3/03; E03B 3/28; B01D 5/0051

(57) ABSTRACT

The invention is a system and method for the generation of usable water from atmospheric water vapor for dispersal through water sprinklers.

### CROSS REFERENCE TO RELATED APPLICATIONS

This application is a continuation-in-part of U.S. patent application Ser. No. 16/152,786, filed on Oct. 5, 2018.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a system and method for the generation of usable water from atmospheric water vapor for dispersal through water sprinklers.

### Background of the Invention

Dehumidifying technology was pioneered in an effort to keep indoor humidity levels low, primarily for comfort and reduction in housing/commercial structures. Within geographic areas of high humidity, the technology will convert humidity into water through condensation. With the inclusion of filtering devices, the same technology has become known as atmospheric water generation (AWG).

Atmospheric water generation uses dehumidifying technology with added filters to generate usable and/or potable water. The invention as described and claimed herein is intended for the purposes utilizing native humidity to produce water for agricultural and/or landscape irrigation.

As with any power device located in a remote or isolated area, power generation is a key problem to be addressed. For areas where connection to a public power grid is difficult or impossible, the employment of alternative energy sources such as wind and solar are to be considered.

The rate at which water can be produced depends on relative humidity and ambient air temperature and size of the compressor. Atmospheric water generators become more effective as relative humidity and air temperature increase. As a rule of thumb, cooling condensation atmospheric water generators do not work efficiently when the temperature falls below 18.3° C. (65° F.) or the relative humidity drops below 30%. Thus, an AWG system is likely to function at a more efficient rate in warmer climates or during warmer growing seasons, especially during daylight hours.

With the addition of activated carbon filtering, AWG devices can provide a source of natural and safe water for irrigation within areas of suitably high humidity. Generally, dehumidifiers output water via a condensation drip into a water receptacle, thus collecting metallic and chemical elements to render the collected water potentially unsafe for drinking or agricultural use. As such, additional filtration mechanisms are recommended to prepare harvested water for safe human use.

Known AWG systems fail to combine features of self-generating power with water generation, transportation and filtration means feasible for a full on-site agricultural or landscape sprinkler-based irrigation system or a fire prevention sprinkler system for one or more structures. Applicant's claimed system and methods achieve these objectives for the generation, and dispersal usable water from atmospheric water vapor.

### BRIEF SUMMARY OF THE INVENTION

In a preferred embodiment, an atmospheric water generation and sprinkler system comprising a case, air fans to pull atmospheric air into the case, wherein a compressor-type dehumidifier condenses water from atmospheric vapor and drains the condensed water into a collection tank, one or more water pumps located in the collection tank pump the condensed water into an outflow pipe for delivery to one or more sprinkler lines and then to a plurality of sprinkler heads.

In another preferred embodiment, the atmospheric water generation and sprinkler system of as described herein, wherein a power line from a generator connects to an amplifier in or on the case, then extends to one or more capacitors, which capacitor(s) are each connected by inner power lines, directly or indirectly, to one or more air fans, dehumidifier components and water pumps.

In another preferred embodiment, the atmospheric water generation and sprinkler system of as described herein, further comprising wherein the case containing dehumidifier and collection tank is located on an elevated platform, and the outflow pipe drainage tube extends towards the ground, ending in a nozzle focused on an impact water turbine for generating power before flowing on to the sprinkler lines.

In another preferred embodiment, the atmospheric water generation and sprinkler system of as described herein, further comprising wherein the outflow pipe feeds into a turbine basin, wherein the water turbine is a reaction turbine and fully submerged when operating.

In another preferred embodiment, the atmospheric water generation and sprinkler system of as described herein, wherein the turbine is wired and provides power to a generator which in turn powers some or all of the air fans, dehumidifier components and water pump(s).

In another preferred embodiment, the atmospheric water generation and sprinkler system of as described herein, wherein one or more water filters are located in the water pump or outflow pipe.

In another preferred embodiment, the atmospheric water generation and sprinkler system of as described herein, wherein the sprinkler lines are of a lesser diameter than the outflow pipe.

In another preferred embodiment, the atmospheric water generation and sprinkler system of as described herein, further comprising a dessicant-type dehumidification system, either in addition to or in lieu of a compression-type dehumidification system.

In another preferred embodiment, the atmospheric water generation and sprinkler system of as described herein, wherein the sprinklers are agricultural.

In another preferred embodiment, the atmospheric water generation and sprinkler system of as described herein, further comprising a first miniaturized water turbine(s) located within the sprinkler line, such turbine(s) placed at each of one or more sprinkler heads.

In another preferred embodiment, the atmospheric water generation and sprinkler system of as described herein, further comprising a second miniaturized water turbine(s) located above each of one or more sprinkler heads.

In another preferred embodiment, a method of providing pressurized water for a plurality of water sprinklers comprising the steps of:
i. dehumidifying atmospheric air using the atmospheric water generator of claim 1,
ii. using a powered water pump to pump condensed water into an outflow pipe,
iii. attaching one or more sprinkler lines, each comprising a plurality of sprinkler heads, to the outflow pipe.

In another preferred embodiment, a method of self-powering a water generation system comprising the steps of:
i. engaging one or more dehumidifier(s);
ii. dehumidifying moist air to form condensation;
iii. draining the condensation from an elevated platform to near ground level via an outflow pipe, thus producing hydrostatic pressure;
iv. using hydrostatic pressure to power a water turbine(s);
v. generating electric power from the water turbine(s); and
vi. providing the generated electric power to some or all electronic components of the system.

### BRIEF DESCRIPTION OF THE DRAWINGS

FIG. 1 is a line drawing evidencing an atmospheric water generation and sprinkler system.

FIG. 2 is a line drawing evidencing an elevated embodiment of the atmospheric water generation and sprinkler system in combination with a water turbine and generator.

FIG. 3 is a line drawing evidencing an individual sprinkler head of the system of FIG. 1, further comprising two miniaturized water turbines.

### DETAILED DESCRIPTION OF THE INVENTION

The invention as described and claimed herein is an atmospheric water generation (AWG) system intended for the purposes of reclaiming atmospheric water for dispersal through a sprinkler system for the purposes of landscaping, agriculture and/or firefighting systems.

AWG technology can intake atmospheric water vapor through evaporator coil heating, using electrical air fans to pull in vapor for condensation and reuse. Once condensed, gravity pulls the resulting liquid water downward from the coils effecting condensation and into a collection tank, which can either be a separate component or an area beneath the coils. In a preferred embodiment, the area at the bottom of the case containing the dehumidification components will serve as the collection tank. In an optional variation of this arrangement, the dehumidification components reside above a catch panel 110 (not pictured), preferably with a funnel design, such that the catch panel catches and directs the condensed water vapor into the collection tank in a controlled manner.

At the bottom of the collection tank area, one or more powered water pumps will be arranged, each connected to a generator by a power line, with each such pump comprising an intake hole for pulling in condensed water and an output hole for pumping out such water. In one embodiment, a carbon filter will be placed to filter out impurities before pumping towards the sprinklers will be placed either at the entrance to or exit from the pump, or within a connected outflow pipe. The output hole will connect to the outflow pipe, which pipe will be of a length necessary to transport the condensed water to the sprinklers to be fed by the condensed water from the system. Such pipe will preferably comprise one or more valves that can be adjusted to regulate flow, either manually or electronically. As the outflow pipe approaches the sprinkler pipes that comprise sprinkler heads, a pressure regulator will be arranged along the pipe.

In one embodiment, the outflow pipe will gradually decrease in diameter according to its length in order to boost pressure as the water travels. Similarly, the sprinkler pipes attached to the end of the outflow pipe may be of a smaller diameter than the outflow pipe, such diameter to be adjusted depending on the length of the sprinkler pipe(s), the number of pipes emanating from a given outflow pipe, and the number of sprinkler heads to be fed.

The sprinkler heads themselves will vary in design depending upon their function, and more than one sprinkler type or size may be used in a given system. For the purposes of agricultural or landscaping irrigation, the sprinklers to be employed may be taken, without limitation, from the group containing pop up, raised, settling, oscillating, rotors, shrub style, spraying, drips, bubblers, flood bubblers, stream bubblers, micro bubblers, misters, etc. For fire sprinklers, head types may be any combination of pendant, upright, sidewall, concealed or any other commercially known variety.

The system invention utilizes known methods of dehumidification. In practice, moist atmospheric air is drawn into a compressor-style dehumidifier mechanism by one or more powered air fans. This air passes into a crossflow plate heat exchanger where a substantial proportion of the sensible heat is transferred to a cool supply air stream. This process brings the extracted air close to saturation. The air then passes across the refrigerant-cooled evaporator coil of the heat pump where the air is cooled and the moisture is condensed. This process yields substantial amounts of latent energy to the refrigeration circuit. Fresh air is then introduced to replace the amount that was extracted and the mix is discharged by the supply fan to the crossflow plate exchanger where it is heated by the extract air from the pool. This pre-warmed air then passes through the heat pump condenser where it is heated by the latent energy removed during the condensation process as well as the energy input to the compressor. The warm dry air is then discharged into the atmosphere. In a given embodiment, the system may further comprise a sensor-activated heater/blower (s) adjacent to the evaporator coils that engages upon sensing ice buildup on the coils.

In an alternate embodiment, the dehumidifier mechanism comprises a desiccant-style dehumidifier, or a combination of compressor-style and desiccant-style dehumidifiers.

In a preferred embodiment, the dehumidifier mechanism is arranged on an elevated platform, such as a rooftop, and some or all the power supply for the system is generated from the gravity-driven water pressure of the condensed water drainage, as captured by a water turbine located at ground level. Such turbine is preferably a rotary machine that converts the kinetic and potential energy of the downward-draining water into mechanical work, generating electric power. While a reaction turbine may be possible, since the condensation will gather velocity during its drainage path down the water tube from the elevated platform, the resulting jet at the point of entry to the ground-based turbine makes the use of an impulse turbine ideal. In another embodiment, two or more drainage tubes and respective turbines may be employed. In such an embodiment, the multiple turbines may connect to a single generator, or to respective generators, each powering a subset of the system's electrical components.

Calculation of available power is determined by the equation:

Pₜₕ=ρq g h
where
Pₜₕ=power theoretically available (W)
ρ=density (kg/m³) (˜1000 kg/m³ for water)
q=water flow (m³/s)
g=acceleration of gravity (9.81 m/s²)
h=falling height, head (m)

### DETAILED DESCRIPTION OF THE FIGURES

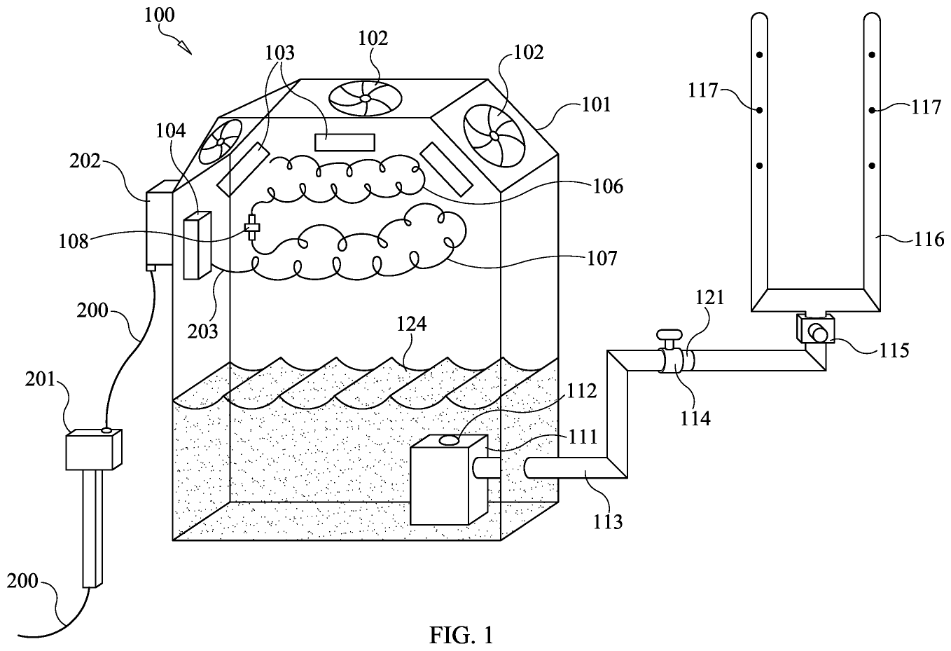

FIG. 1 shows a cross-section of an atmospheric water generating system 100, wherein all dehumidification components and water collection is contained within a case 101, which case will generally be constructed of a plurality of panels. The case shall be comprised of one or more rigid, protective material(s) including but not limited to metal or metal alloy, carbon fiber, fiberglass or polymers, including but not limited to polypropylene, polystyrene, high impact polystyrene, polyethylene, ETFE, FEP, PCTFE, PFA, PTFE, PVDF, HDPE, LDPE, PCTFE, PAI, and any known variations of the foregoing. In a preferred embodiment, the case components would be jointed to allow for an acceptable degree of flexibility in response to wind pressure or a physical concussion, such as a landing impact. Such jointing could take any known form including but not limited to bolting, snap-fitting, pinning and/or spring-loading for shock absorption. Components of the shell/frame require sufficient strength to support the weight of the fans, electrical and dehumidifier components.

Some or all of the joints between case panels will be waterproofed by caulking or similar means to allow for capture of condensation without leaking. In one preferred embodiment, the lower portion of the case will be a single integral component to serve as a collection tank.

Within the case 101, a plurality of air fans 102 are located, with each fan intaking surrounding air and passing such air across or through a crossflow heat exchanger 103, optionally to include an expansion valve (not pictured) to harvest the water vapor within. The fans and all other electronic components within the shell are powered via one or more power lines 200, each running directly or indirectly to a ground-based generator or similar power source (not pictured). The power line running from the power source will pass through a control box 201 outside the case, and thence to capacitor 202, before entering the case through a hole (not pictured) mounted near or behind the capacitor. Immediately upon entering the case, the power line 200 will pass through an amplifier 104 and then run on to power various components within the airborne platform. In one embodiment, the power line will split into multiple interior power lines 203 and run to various components.

A control box houses a commercial user interface console to configure water pressure (in PSIs), direct/alternate current initialization from regional power grids, and timing initiations for sprinkler execution. Components generally include an electronic source (ground) wire to connect either into an alternating current power outlet or directly into a fuse box and a series of controller wires connected via solenoids to carry current into onboard capacitors or transformers 202. The control box is power relay from residential home power supplies to sprinkler systems.

In the figure, inter power lines run from the amplifier to a compressor 105 and a plurality of capacitors 120, which store power and then deliver current to respective air fans for either intake or exhaust of air through the shell. It is also possible that additional power lines could run from solar panels or wind turbines mounted on the shell 101 to provide an alternate power source(s).

FIG. 1 further indicates a classic compression-type dehumidifier model, wherein a compressor 105 compresses a refrigerant (for example, without limitation, commercially known chlorofluorocarbons, hydrochlorofluorocarbons, or hydrofluorocarbons) in gas form and pumps it through a set of condenser coils 106, where the gas heats and becomes a liquid, with the condenser coils dissipating the heat. The refrigerant liquid then passes through an expansion valve(s) 108 and into separate evaporator coils 107, where the refrigerant expands into a gas, thereby dropping in temperature and cooling the evaporator coils before returning to the compressor. The expansion valves provide dynamic resistance and flow control over the amount of refrigerant released into the evaporator.

Air is taken in by an air fan(s) 102, which then pushes the air over the cold evaporator coils 107 to lower the air temperature and effect condensation of the airborne water vapor into liquid water, which gathers on the evaporator and drips downward into collection tank 109, while the air is pulled across the heated condenser coils 106 before being ejected as exhaust by air fans. Functioning together, the air fans, compressor, condenser coils, evaporator coils and expansion valves comprise a dehumidifier.

In one embodiment, the collection tank 109 is embodied as the lower portion of the space within the case 101, wherein the vapor, once condensed into a liquid, is pulled into the collection tank by gravity. In a preferred embodiment, the collection tank is employed as a single, integral component, either lined or unlined to minimize the prospect of leaking. In another preferred embodiment, the collection tank is comprised of a liner (not pictured) within the lower portion of the case 101, wherein the case itself is constructed of panels. Preferred materials for the liner include, without limitation, fiberglass, ceramics, vinyl such as PVC or similar polymers, or lightweight, corrosion resistant metal sheeting.

In an alternate embodiment, the compression-style dehumidifier of FIG. 1 may be replaced with an alternative technology using liquid, or “wet” desiccants such as lithium chloride or lithium bromide to pull water from the air via hygroscopic processes. A similar technique is also practicable combining the use of solid desiccants, such as silica gel and zeolite, with pressure condensation.

One or more electrically powered water pumps 111 will be arranged on the floor of the case 101, inside the collection tank 109. Preferably, each water pump will be located at or near the wall of the case. Each water pump will have an intake hole 112 for pulling in condensed water and will then pump water into an outflow pipe 112, which pipe will take the water through the case and towards the sprinklers. In this embodiment, filter 121 is indicated within the outflow pipe, for the removal of salt, metals and other harmful contaminants. Preferably, the filter would be mesh and/or carbon-based, and may be located close to an outflow pipe valve 114 for ease of maintenance access.

In one embodiment, a carbon filter (not pictured) will be placed over the intake hole to filter out impurities before pumping towards the sprinklers to be fed by the system. Such pipe will likely comprise one or more outflow pipe valves 114 that can be adjusted to regulate flow, either manually or electronically. In another embodiment, such filter may be placed inside the outflow pipe 113 at an outflow pipe valve 114, thereby allowing the outflow to be temporarily cut off by the valve for cleaning and/or replacement of such filter. As the outflow pipe approaches the sprinkler pipes 116 that comprise sprinkler heads 117, a pressure regulator 115 will be arranged along the outflow pipe.

The pressure regulator can be configured via a multitude of ways however, this can be configured both manually via mechanical triggers or automatically via software rules and remote sensing applications. Configuration agnostic, a pressure regulator is first triggered when water enters a throttling stem from the input valve. The throttling stem is held open via a spring system housed around the hollow tube and diaphragms attempt to seal the output valve; pressure is then regulated by the compression strength of the springs surrounding the throttling stem as water traverses the regulator. For optimum results, the regulator should be located between the pipe valves 114 and the sprinkler lines 116.

As pictured in FIG. 1, the outflow pipe 113, after passing through the pressure regulator 115, branches into two separate sprinkler lines 116. The use of two sprinkler lines is merely illustrative, as the system will comprise as few sprinkler lines as necessary and as many as the water pressure generated by the water pump 111 in the outflow pipe 113 will allow. In a preferred embodiment, the outflow line itself will gradually decrease in diameter as the distance from the water pump elongates, thus boosting water pressure along the length of the pipe. Similarly, the diameter of individual sprinkler lines 116 will likely be less than that of the outflow pipe, also to aid in maintaining a functional level of water pressure for the sprinkler heads 117.

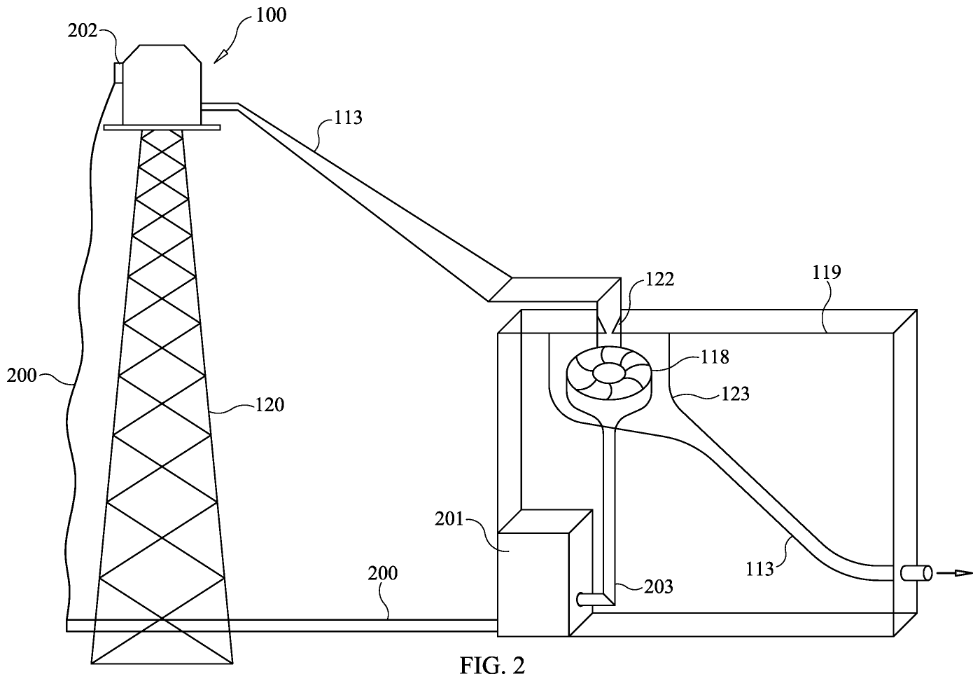

FIG. 2 illustrates the AWG system 100, as detailed in FIG. 1, arranged on an elevated platform 120. Rather than a free-standing platform, the roof of a structure of sufficient height might also be used. As the condensed water from dehumidification of atmospheric air is gathered within case 101 and is pumped into outflow pipe 113 where it flows downward towards the ground, the effect of gravity on the water generates an increasing pressure level in the downward direction. The outflow pipe may optionally contain one or more control valves 202 that can be adjustably opened and closed to manage the pressure level. It should be noted that the embodiment of the AWG system residing on an elevated platform may not require a water pump, but the outflow pipe 113 may instead be fitted directly into the floor of the collection tank (not pictured) to allow for gravity-driven drainage.

In the embodiment of FIG. 2, the outflow pipe 113, upon reaching ground level, enters a turbine basin 119 containing a water turbine 118. The effect of gravity on the downward-flowing water through the pipe will eject such water into the turbine 118 seated in a turbine tank 123. The turbine is connected by an internal power line 203 to the generator 201. The generator will create usable wattage by electromagnetic induction, using the rotational energy produced by the turbine to spin a coil of conductive wire inside a magnetic field. This generator technology is well known and the generator components are thus not pictured. The water pump sends water from the turbine tank 123 into and through a second stretch of outflow pipe 113, out of the turbine basin and to the sprinkler lines (not pictured). In an alternate embodiment, the turbine reduces the water pressure such that a second water pump 111 (not pictured) is arranged where the turbine tank empties into the second stretch of outflow pipe 113. Such pump would be powered from an internal power line from generator 201.

In one embodiment, the outflow pipe further comprises a 122 arranged above its entry to the water turbine 118 to build hydrostatic pressure and focus that pressure on the turbine beneath to increase power generation. In this embodiment, the water turbine is best embodied as an impact turbine. In another embodiment, no nozzle is provided, but the turbine tank is designed to fill with condensation and thus submerge the turbine completely. In such embodiment, the water turbine is best embodied as a reaction turbine.

Water contained in a volume of air fluctuates with a combination of geological and atmospheric variables. The reverse sprinkler AWG platform 100 can intake native humidity the purpose of re-provisioning water into ground soils. As by way of example, the Eastern United States has an approximate 60% humidity level; thus, 60% per 1 kg/m3 of air contains water vapor. The calculation to determine relative humidity is:

RH=Pw/Pws−100%

Where RH is relative humidity, Pw is water vapor pressure, and Pws is saturated water vapor pressure. The calculation of measuring flow rate is:

Q=A*V

Where Q is the flow rate, A is the cross-sectional area flow, and V is the velocity of flow.

Assuming an area comprises of 60% RH and with an intake rate of 5 gallons per minute (gpm), the platform raided to 100 ft (30 meters), a diameter water pipe of 4 inches, and utilizing the formula as detailed herein above, outputs the following results:

p=600

q=0.0003116656 m3/s

g=9.81 m/s2

h=30 m

This example would yield a total of 55.03 W of available energy per one day of continuous operation.

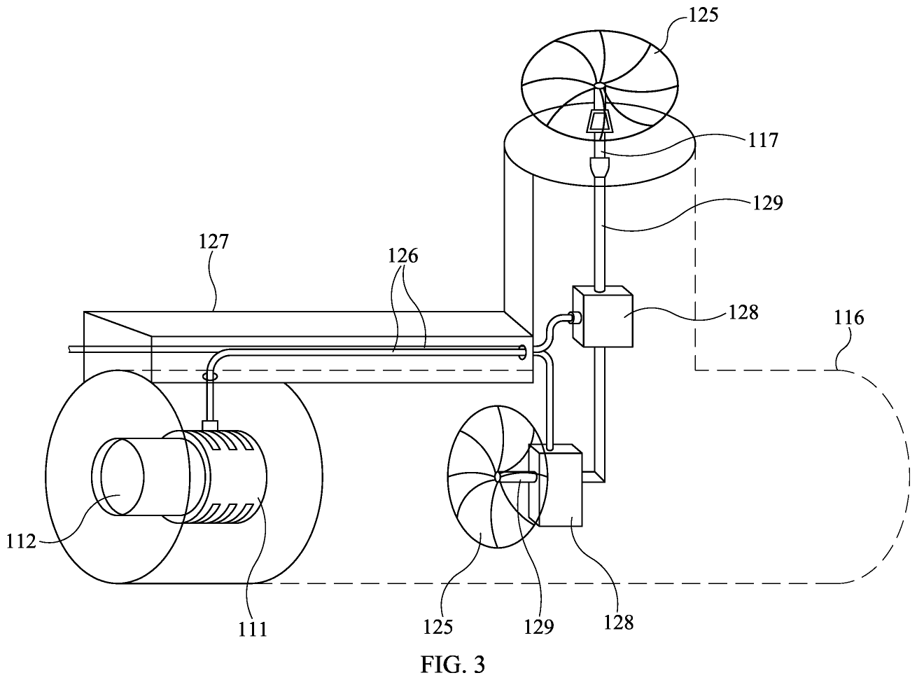

FIG. 3 shows an alternate embodiment, in which a miniaturized turbine is arranged before, preferably at or near the base of, one or more individual sprinkler heads 117. This allows the larger sprinkler system to continuously convert water pressure into mechanical, and subsequently electrical, energy to repurpose for other means. Though most commercial and residential sprinkler systems have direct access to a AC/DC power control box 201, this would provide two supplemental functions: a remote deployment of the reverse AWG sprinkler system without direct energy supply, allowing energy flow back into the design for complete or partial self-sustainability, as well as a potential sell-back of power to the nearest commercial/residential transformer owned by a public utility. Such an application could utilize a power system, potentially including rechargeable batteries, capable of simultaneously or intermittently drawing power from such system turbine(s) as well as other on-site power sources such as solar panels or windmills.

FIG. 3 evidences one miniaturized turbine 125 seated within the horizontal sprinkler line 116, such turbine connected by a generator shaft 129 to a turbine generator 128, which generator is connected to small gauge wires 126 running out and through wire gauge box 127. Located within the horizontal sprinkler line 116 prior to the turbine is water pump 111, which is also fed by wires running through the wire gauge box. Such turbine may alternately be seated within the vertical portion of the sprinkler line. A second miniaturized turbine 125 is seated above the sprinkler head 117 above the vertical sprinkler line 116, which second turbine is positioned to spin using the force of the water expelled by the sprinkler head. In the pictured embodiment, the second turbine is connected to a second turbine generator 128.

In practice, each miniaturized turbine 125 can be located in either a horizontal or vertical position within the sprinkler line 116 below a sprinkler head 117, and/or be mounted outside the water line above the sprinkler head. In one embodiment, each turbine is wired to an individual turbine generator 128, while in another embodiment, two or more turbines are collectively wired to a single turbine generator.

The calculation used to measure water pressure at the head of sprinkler/fire suppressant systems is:

k=q/p^{0.5}

k=k factor (or nozzle discharge coefficient)

q=flow rate (gpm)

p=pressure (psi)

Electromagnetic induction would occur in the platform housing 100 where the raw conversion would execute immediately before the water exited the sprinkler head 117. This could be accomplished via small gauge wires 126 running from each miniaturized turbine 125 back to the onboard capacitor and transformer 202 (not pictured). Wires would be most optimal for placement along the outside of the water pipes 116 for ease of maintenance, preferably within an attached wire gauge box 127. Assuming sufficient water pressure, an optional secondary miniaturized turbine could be located on top of each sprinkler head 117 to enable an even higher k-factor coefficient. Due to velocity loss from friction of water flow travel in pipes 116 and turbine encounters pre/post sprinkler head 117, the addition of one water pump per line of water pipes 116 is preferred to increase water pressure to account for these kinetic energy losses thus, provisioning water pressure and velocity modulation from the pressure regulator 115.

### INDEX OF PARTS

100 AWG System
101 Case
102 Air fan
103 Crossflow heat exchanger
104 Amplifier
105 Compressor
106 Condenser coils
107 Evaporator coils
108 Expansion valves
109 Collection tank
110 Catch panel
111 Water pump
112 Intake hole
113 Outflow pipe
114 Valve
115 Pressure regulator
116 Sprinkler lines
117 Sprinkler heads
118 Turbine
119 Turbine basin
120 Elevated platform
121 Filter
122 Nozzle
123 Turbine tank
124 Condensed water
125 Miniaturized turbine
126 Small gauge wires
127 Wire gauge box
128 Turbine generator
129 Generator shaft
200 Power lines
201 Control box
202 Capacitor/transformer
203 Interior power lines

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. An atmospheric water generation and sprinkler system comprising a case, air fans to pull atmospheric air into the case, wherein a compressor-type dehumidifier condenses water from atmospheric vapor and drains the condensed water into a collection tank, one or more water pumps located in the collection tank pump the condensed water into an outflow pipe for delivery to one or more sprinkler lines and then to a plurality of sprinkler heads.

2. The atmospheric water generation and sprinkler system of claim 1, wherein a power line from a generator connects to an amplifier in or on the case, then extends to one or more capacitors, which capacitor(s) are each connected by inner power lines, directly or indirectly, to one or more air fans, dehumidifier components and water pumps.

3. The atmospheric water generation and sprinkler system of claim 1, further comprising wherein the case containing dehumidifier and collection tank is located on an elevated platform, and the outflow pipe drainage tube extends towards the ground, ending in a nozzle focused on an impact water turbine for generating power before flowing on to the sprinkler lines.

4. The atmospheric water generation and sprinkler system of claim 3, further comprising wherein the outflow pipe feeds into a turbine basin, wherein the water turbine is a reaction turbine and fully submerged when operating.

5. The atmospheric water generation and sprinkler system of claim 3, wherein the turbine is wired and provides power to a generator which in turn powers some or all of the air fans, dehumidifier components and water pump(s).

6. The atmospheric water generation and sprinkler system of claim 1, wherein one or more water filters are located in the water pump or outflow pipe.

7. The atmospheric water generation and sprinkler system of claim 1, wherein the sprinkler lines are of a lesser diameter than the outflow pipe.

8. The atmospheric water generation and sprinkler system of claim 1, further comprising a dessicant-type dehumidification system, either in addition to or in lieu of a compression-type dehumidification system.

9. The atmospheric water generation and sprinkler system of claim 1, wherein the sprinklers are agricultural.

10. The atmospheric water generation and sprinkler system of claim 1, further comprising a first miniaturized water turbine(s) located within the sprinkler line, such turbine(s) placed at each of one or more sprinkler heads.

11. The atmospheric water generation and sprinkler system of claim 10, further comprising a second miniaturized water turbine(s) located above each of one or more sprinkler heads.

12. A method of providing pressurized water for a plurality of water sprinklers comprising the steps of:
i. dehumidifying atmospheric air using the atmospheric water generator of claim 1,
ii. using a powered water pump to pump condensed water into an outflow pipe,
iii. attaching one or more sprinkler lines, each comprising a plurality of sprinkler heads, to the outflow pipe.

13. A method of self-powering a water generation system comprising the steps of:
i. engaging one or more dehumidifier(s);
ii. dehumidifying moist air to form condensation;
iii. draining the condensation from an elevated platform to near ground level via an outflow pipe, thus producing hydrostatic pressure;
iv. using hydrostatic pressure to power a water turbine(s);
v. generating electric power from the water turbine(s); and
vi. providing the generated electric power to some or all electronic components of the system.
